(19) United States
(12) Patent Application Publication
(10) Pub. No.: US 2012/0072179 A1
(43) Pub. Date: Mar. 22, 2012

(54) SYSTEM AND METHOD FOR DESIGNING CUSTOM FRAMING OF ARTWORK

(75) Inventors: Jay PATEL, Duluth, GA (US); Christopher FRALEY, Dacula, GA (US); Greg PERKINS, Suwanee, GA (US)

(73) Assignee: LARSON-JUHL US LLC, Norcross, GA (US)

(21) Appl. No.: 12/886,958

(22) Filed: Sep. 21, 2010

(51) Int. Cl. G06F 17/50

(52) U.S. Cl. 703/1

(57) ABSTRACT

The exemplary embodiments of the present invention provide a system, method and computer program products for designing custom framework components for an image. The method includes receiving the image to be framed and determining if the image to be framed is to include a mat as one of the framework components. The method further includes determining if a molding is to be utilized as one of the framework components and resizing the framework components in proportion to the image to be framed.

### FIELD OF THE INVENTION

The present invention generally relates to framing artwork, and more particularly, to a system and method for designing custom framing of artwork or images.

### BACKGROUND

A picture frame is a container for a picture, such as a painting or photograph, intended to enhance it, make it easier to display, or protect it. Until recently, one generally went to a dedicated picture framing store when one wanted to frame a piece of artwork. Now with the proliferation of website applications on the World Wide Web, a user can now visualize the effects of selecting a variety of component materials to custom frame the artwork.

However, currently there are some limitations with regard to visualizing the framing of the artwork.

### BRIEF SUMMARY

Embodiments of the present invention provide a system, method and computer program products for providing custom framing system.

An exemplary embodiment includes a method for providing custom framing system. The method includes receiving the image to be framed and determining if the image to be framed is to include a mat as one of the framework components. The method further includes determining a molding to be utilized as one of the framework components and resizing the framework components in proportion to the image to be framed.

Another exemplary embodiment includes a system for providing custom framing system. Briefly described in terms of architecture, one embodiment of the system, among others, is implemented as follows. The system includes an image module that receives the image to be framed and a mat module that determines if the image to be framed is to include a mat as one of the framework components. The system further includes a molding module that determines a molding to be utilized as one of the framework components and a resizing module that resizes the framework components in proportion to the image to be framed.

A further exemplary embodiment includes a computer program product for providing custom framing system. The computer program product includes a tangible storage medium readable by a computer system and storing instructions or execution by the computer system for performing a method. The method includes receiving the image to be framed and determining if the image to be framed is to include a mat as one of the framework components. The method further includes determining a molding to be utilized as one of the framework components and resizing the framework components in proportion to the image to be framed.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the system and method for designing custom framing of artwork on the World Wide Web of the present invention.

FIG. 2 is a block diagram illustrating an example of a server utilizing the custom framing system of the present invention, as shown in FIG. 1.

FIG. 3 is a block diagram illustrating an example of the components of a framed piece of artwork that can be designed using the custom framing system of the present invention, as shown in FIG. 2.

FIG. 4 is a flow chart illustrating an example of the operation of the custom framing system of the present invention, as shown in FIG. 2.

FIG. 5 is a flow chart illustrating an example of the operation of the artwork process on the server utilized in the custom framing system of the present invention, as shown in FIGS. 2 and 4.

FIG. 6 is a flow chart illustrating an example of the operation of the mats process utilized in the custom framing system of the present invention, as shown in FIGS. 2 and 4.

FIG. 7 is a flow chart illustrating an example of the operation of the frames process utilized in the custom framing system of the present invention, as shown in FIGS. 2 and 4.

FIG. 8 is a flow chart illustrating an example of the operation of the analysis process utilized in the custom framing system of the present invention, as shown in FIGS. 2 and 4.

FIG. 9 is a flow chart illustrating an example of the operation of the dealer process utilized in the custom framing system of the present invention, as shown in FIGS. 2 and 4.

The detailed description explains the preferred embodiments of the invention, together with advantages and features, by way of example with reference to the drawings.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

One or more exemplary embodiments of the invention are described below in detail. The disclosed embodiments are intended to be illustrative only since numerous modifications and variations therein will be apparent to those of ordinary skill in the art.

Given a system and method for providing custom framing, a visitor to upload an image of their choice, or select one from the artwork offering available a plurality of different websites. The visitor can then visualize the effect of selecting a variety of component materials to custom frame the image. For this purpose the components offered are: moldings (frame), mats, fillets (thin frames), liners, and glass.

Utilizing the system and method for providing custom framing of the present invention, the visitor can build complex designs that could include at least a stack of three moldings, three layers of mats, and up to 6 fillets. The visitor can print the outcome with the “recipe” for the build, or email the design configuration directly to their framer of choice.

The major differences between the custom framing system of the present invention and other framing websites are as follows. In one alternative embodiment, the custom framing system of the present invention will show the inside molding (i.e. the framing or fillet) properly tucked under the outside molding, the way a framer would actually build a frame, while other framing websites show the inside molding right next to the outside molding, thus avoiding the complex programming for the overlap.

Another major difference is that the custom framing system of the present invention, in another alternative embodiment, displays all components scaled to the size of the selected image. For example, if a selected image is 16″ wide and the website is going to scale it down to a 4″ width for the web page, a 2″ wide molding, wrapped around the image, will also be scaled down to ½″. This will also be so for the mats, if selected. Again, this allows the website visitor to better visualize the real situation. In still another alternative embodiment, a zooming feature maintains the scale described above while displaying the enlarged configuration. This allows the visitor to view the details of all components he/she has selected to custom frame their image.

Another major difference is if the visitor selects mats to border-around the image, other framing websites allow all four borders to be of the same width. This is in contrast to another alternative embodiment of the custom framing system of the present invention that allows a more sophisticated design by allowing borders of varying widths.

In still another alternative embodiment, the custom framing system of the present invention provides design rules to avoid aesthetically bad choices of components. For example, a predominantly dark blue image will not be eye-appealing with a blue mat and a black molding. Through design rules, in the custom framing system of the present invention will display components for selection considered appropriate by the industry design experts. An override feature will also be added for a visitor who wants to pass on the suggestions.

In still another alternative embodiment, the custom framing system of the present invention offers the ability to select multiple images to fit multiple mat openings in one frame configuration. For example, a need to visualize such a configuration could be family photographs of parents and their children all in one frame. The multiple mat openings include, but are not limited to, a variety of shapes besides the standard rectangle, circle, oval, hexagon, and the like. In still another alternative embodiment, the custom framing system of the present invention offers the ability to select multiple mats or layering of multiple mats around an image with one opening, or for multiple images with multiple openings. Other framing websites offer only one square or rectangle mat opening to fit the image within.

When a design includes more than one mat, the part of the mat/s, that shows, underneath the top mat, is called “reveal”. Published websites allow default size for the reveal. In still another alternative embodiment, the custom framing system of the present invention offers the ability to the visitor to choose the width of each reveal.

Most frames are back-loaded, i.e., glass, mats, art, etc. are dropped in from the back side of the frame, with a lip to hold it all in place. A float frame is used to frame a canvas. The cross-section of the molding used is ‘L’ shaped with a base/lip that holds the canvas. It is front-loaded so the entire canvas shows. In still another alternative embodiment, the custom framing system of the present invention offers the ability to the visitor to select the amount of the frame that shows.

Other websites allow a visitor to upload an image from a directory on their computer, but do not include a feature to access and fetch image from another website. In still another alternative embodiment, the custom framing system of the present invention offers the ability to access and fetch image from a third-party website.

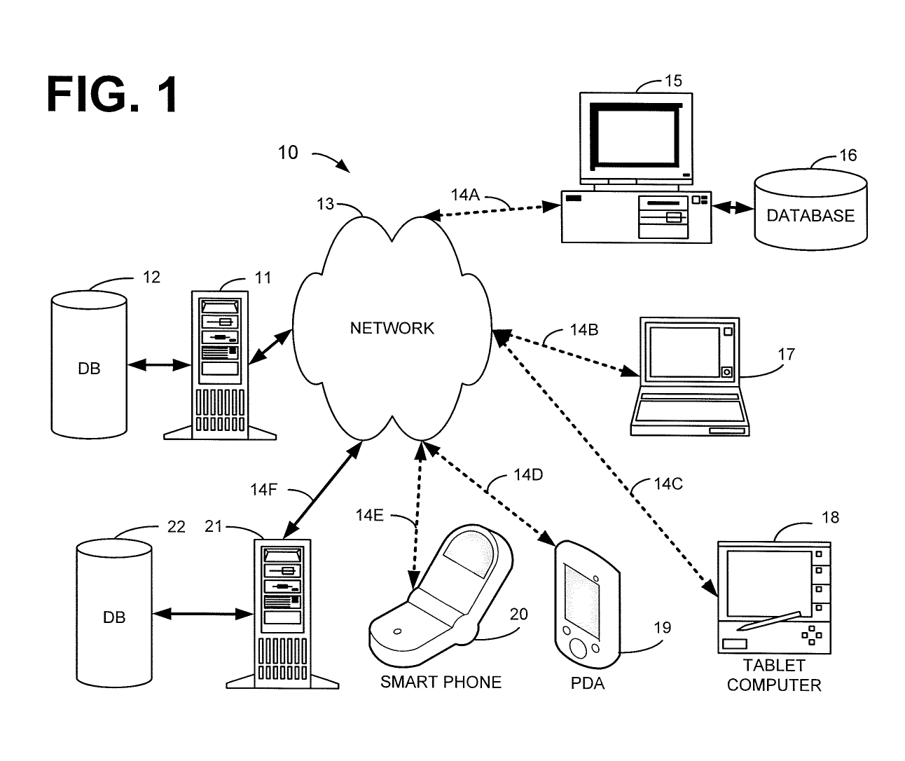

Referring now to the drawings, in which like numerals illustrate like elements throughout the several views, FIG. 1 illustrates an example of the basic components of a system 10 using the custom framing system on the World Wide Web used in connection with the preferred embodiment of the present invention. The system 10 includes a server 11 and the remote devices 15 and 17-20 that utilize the custom framing system on the World Wide Web system of the present invention.

Each remote device 15 and 17-20 has applications and can have a local database 16. Server 11 contains applications, and a database 12 that can be accessed by remote device 15 and 17-20 via connections 14(A-E), respectively, over network 13. The server 11 runs administrative software for a computer network and controls access to itself and database 12. The remote device 15 and 17-20 may access the database 12 over a network 13, such as, but not limited to, the Internet, a local area network (LAN), a wide area network (WAN), a telephone line using a modem (POTS), Bluetooth, WiFi, WiMAX, cellular, optical, satellite, RF, Ethernet, magnetic induction, coax, RS-485, and the like. The server 11 may also be connected to the local area network (LAN) within an organization.

The remote devices 15 and 17-20 may each be located at remote sites. Remote devices 15 and 17-20 include, but are not limited to, PCs, workstations, laptops, handheld computers, pocket PCs, PDAs, pagers, WAP devices, non-WAP devices, cell phones, palm devices, printing devices, and the like. Included with each remote device 15 and 17-20 is an ability to request relevant material from a large collection of documents. Thus, when a user at one of the remote devices 15 and 17-20 desires to utilize the custom framing system on the World Wide Web from the database 12 at the server 11, the remote device 15 and 17-20 communicates over the network 13, to access the server 11 and database 12.

A third party computer system 21 and database 22 can be accessed by the custom framing system 100 on server 11 in order to provide access to additional collections of documents and/or search indices. Data that is obtained from a third party computer system 21 and database 22 can be stored on server 11 and database 12 in order to provide later access to the user on remote devices 15 and 17-20. It is also contemplated that, for certain types of data, the remote devices 15 and 17-20 can access the third party computer system 21 and database 22 directly using the network 13.

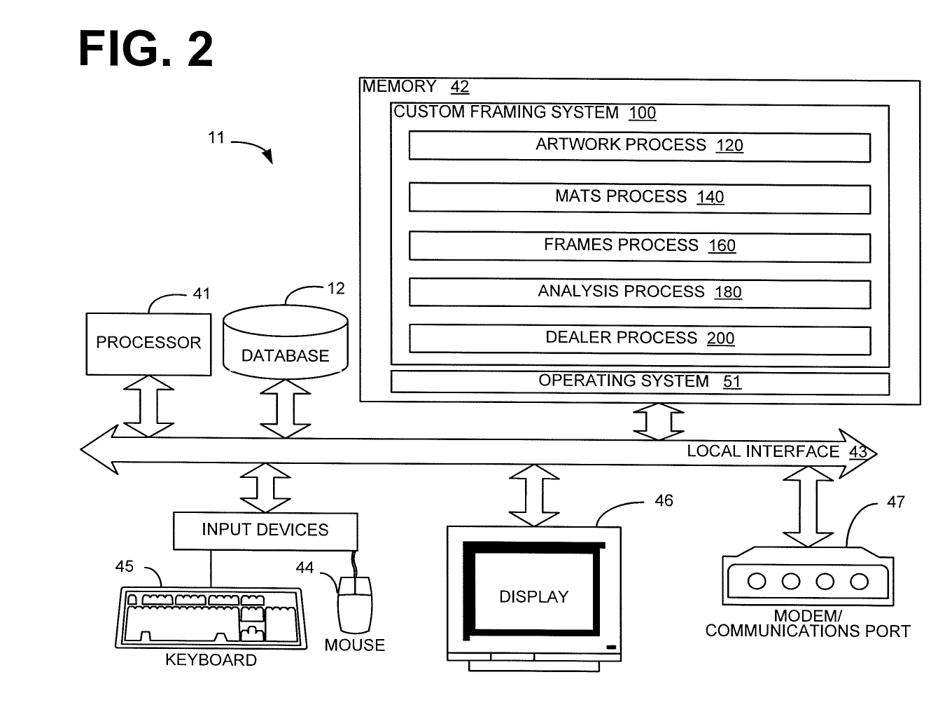

Illustrated in FIG. 2 is a block diagram demonstrating an example of server 11, as shown in FIG. 1, utilizing the custom framing system 100 of the present invention. Server 11 includes, but is not limited to, PCs, workstations, laptops, PDAs, palm devices, and the like. The processing components of the third party computer system 21 are similar to that of the description for the server 11.

As shown in FIG. 2, generally, in terms of hardware architecture, the server 11 includes a processor 41, a computer readable medium such as memory 42, and one or more input and/or output (I/O) devices (or peripherals) that are communicatively coupled via a local interface 43. For example, the local interface 43 can be, but is not limited to, one or more buses or other wired or wireless connections as is known in the art. The local interface 43 may have additional elements, which have been omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or a combination of volatile memory elements. For example, random access memory (RAM), dynamic random access memory (DRAM), static random access memory (SRAM), or nonvolatile memory elements (e.g., ROM, programmable read only memory (PROM), erasable programmable read only memory (EPROM), electronically erasable programmable read only memory (EEPROM), tape, compact disc read only memory (CD-ROM), disk, diskette, cartridge, cassette or the like). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2, the software in the memory 42 includes a suitable operating system (O/S) 51 and the custom framing system 100 of the present invention. As illustrated, the custom framing system 100 of the present invention comprises numerous functional components including, but not limited to, the artwork process 120, mats process 140, frames process 160, analysis process 180 and dealer process 200.

A non-exhaustive list of examples of suitable commercially available operating systems 51 includes the following: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 51 essentially controls the execution of other computer programs, such as the custom framing system 100, and provides scheduling, input-output control, file and data management, memory management, and communication control and related services. However, it is contemplated by the inventors that the custom framing system 100 of the present invention is applicable on all other commercially available operating systems.

The custom framing system 100 may be a source program, browser program, executable program (object code), script, or any other entity comprising a set of computer program instructions to be performed. If a source program, then the program is usually translated via a compiler, assembler, interpreter, or the like, which may or may not be included within the memory 42, to operate properly in connection with the O/S 51. Furthermore, the custom framing system 100 can be written as: (a) an object oriented programming language, which has classes of data and methods; or (b) a procedure programming language, which has routines, subroutines, and/or functions, for example, but not limited to, C, C++, C#, Smalltalk, Pascal, BASIC, API calls, HTML, XHTML, XML, ASP scripts, FORTRAN, COBOL, Perl, Java, ADA, .NET, and the like.

The computer program instructions may execute entirely on server 11, partly on the server 11, as a stand-alone software package, partly on server 11 and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In the preferred embodiment, the custom framing system 100 is implemented on server 11 for execution in a browser on the remote device 15. An example of the custom framing system available on a server that is accessible by a browser can be found by accessing http://www.larsonjuhl.com. Alternative embodiments include a stand-alone system with or without access to a network.

These computer program instructions may also be stored in a computer readable medium that can direct a computer, other programmable data processing apparatus, or other devices to function in a particular manner such that the instructions stored in the computer readable medium produce an article of manufacture, including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The I/O devices may include input devices, for example, but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may include devices that communicate both inputs and outputs, for example, but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and, generally, to control operations of the server 11 are pursuant to the software. The custom framing system 100 and the O/S 51 are read, in whole or in part, by the processor 41, perhaps buffered within the processor 41, and then executed.

When the custom framing system 100 is implemented in software, as is shown in FIG. 2, it should be noted that the custom framing system 100 can be embodied in any computer-readable medium for use by, or in connection with, an instruction execution system, apparatus, or device such as a computer-based system, processor-containing system, or other system that can fetch the instructions from the instruction execution system, apparatus, or device and execute the instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

Program code embodied on a computer readable medium may be transmitted using any appropriate medium, including, but not limited to, wireless, wireline, optical fiber cable, RF, etc., or any suitable combination of the foregoing.

In an alternative embodiment, where the custom framing system 100 is implemented in hardware, the custom framing system 100 can be implemented with any one or a combination of the following technologies, which are each well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The remote devices 15 and 17-20 provides access to the custom framing system 100 of the present invention on server 11 and database 12 using, for example, but not limited to, an Internet browser. The information accessed in server 11 and database 12 can be provided in a number of different forms, including, but not limited to, ASCII data, WEB page data (i.e. HTML), XML or other type of formatted data.

As illustrated, the remote device 15 and 17-20 are similar to the description of the components for server 11 described with regard to FIG. 2. Hereinafter, the remote devices 15 and 17-20 will be referred to as remote device 15 for the sake of brevity.

Aspects of the present invention are described below with reference to flowchart illustrations and/or block diagrams of methods, apparatus (systems) and computer program products according to embodiments of the invention. It should be understood that each block of the flowchart illustrations and/or block diagrams, and combinations of blocks in the flowchart illustrations and/or block diagrams, can be implemented by computer program instructions. These computer program instructions may be provided to a processor in a general purpose computer, special purpose computer, or other programmable data processing apparatus to produce a machine such that the instructions, which execute via the processor of the computer or other programmable data processing apparatus, create the means for implementing the functions/acts specified in the flowchart and/or block diagram block or blocks.

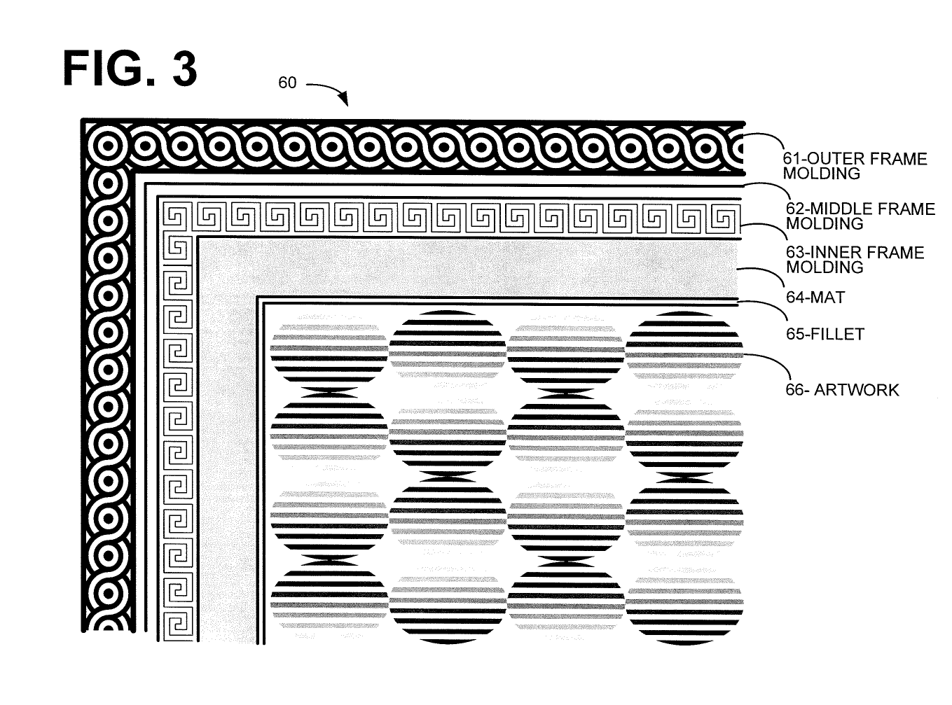

FIG. 3 is a block diagram illustrating an example of the components of a framed piece of artwork that can be designed using the custom framing system 100 of the present invention, as shown in FIG. 2.

Components of a framed piece of artwork may include, but are not limited to the frame molding 61-63, mat 64, fillet 65 and artwork 66. The order in which the inside moldings, liners, fillets, and mats will be placed is entirely up to the person assembling the frame. The custom framing system 100 of the present invention allows this flexibility to its user. It also warns against aesthetically weak designs or combinations, and offers suggestions.

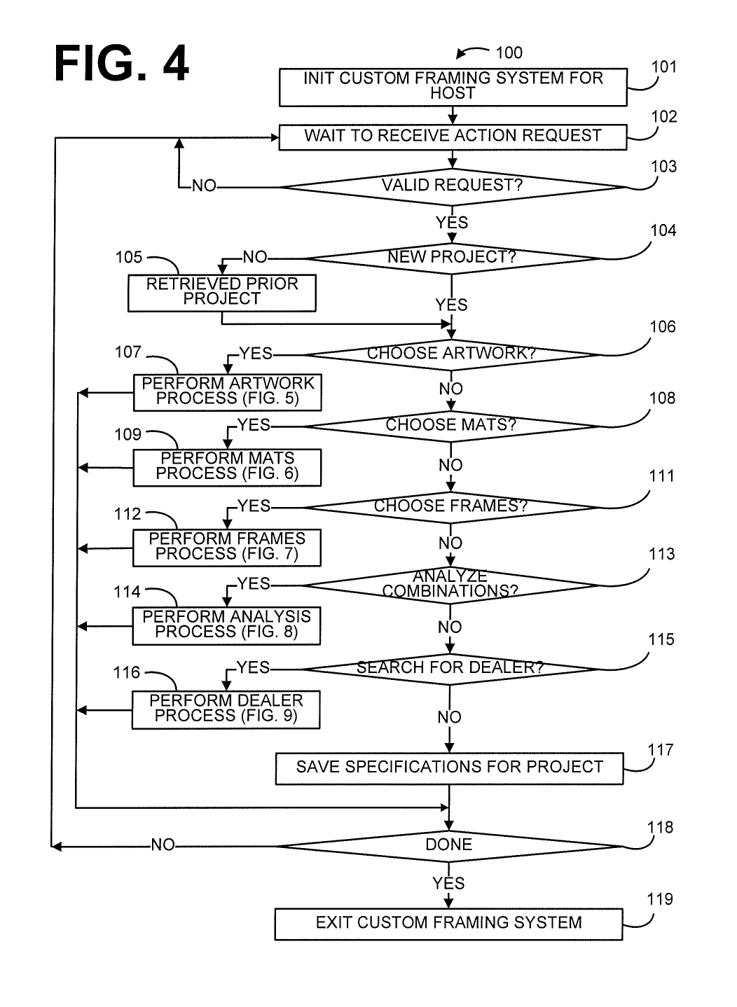

FIG. 4 is a flow chart illustrating an example of the operation of the custom framing system 100 of the present invention utilized by the server 11, as shown in FIG. 2.

First at step 101, the custom framing system 100 is initialized. This initialization includes the startup routines and processes embedded in the BIOS of the server 11. The initialization also includes the establishment of data values for particular data structures utilized in the custom framing system 100.

At step 102, the custom framing system 100 waits to receive an action request. Once an action request is received at step 102, the custom framing system 100 performs the query request at step 103.

At step 103, the custom framing system 100 then determines if the action request is a valid request. In one embodiment, the determination if the action request is valid is determined by validating the action request against metadata. If it is determined at step 103 that the action request is not valid, then the custom framing system 100 returns to step 102 to wait to receive a new action request.

However, if it is determined in step 103 that the action request is valid, then the custom framing system 100 determines if the action request is with regard to a new project at step 104. If it is determined that at step 104 that the action request is with regard to a new project, then the custom framing system 100 skips to step 106. However, if it is determined at step 104 that the action request is not with regard to a new project, then the custom framing system 100 retrieves the data that was saved with regard to a prior project at step 105.

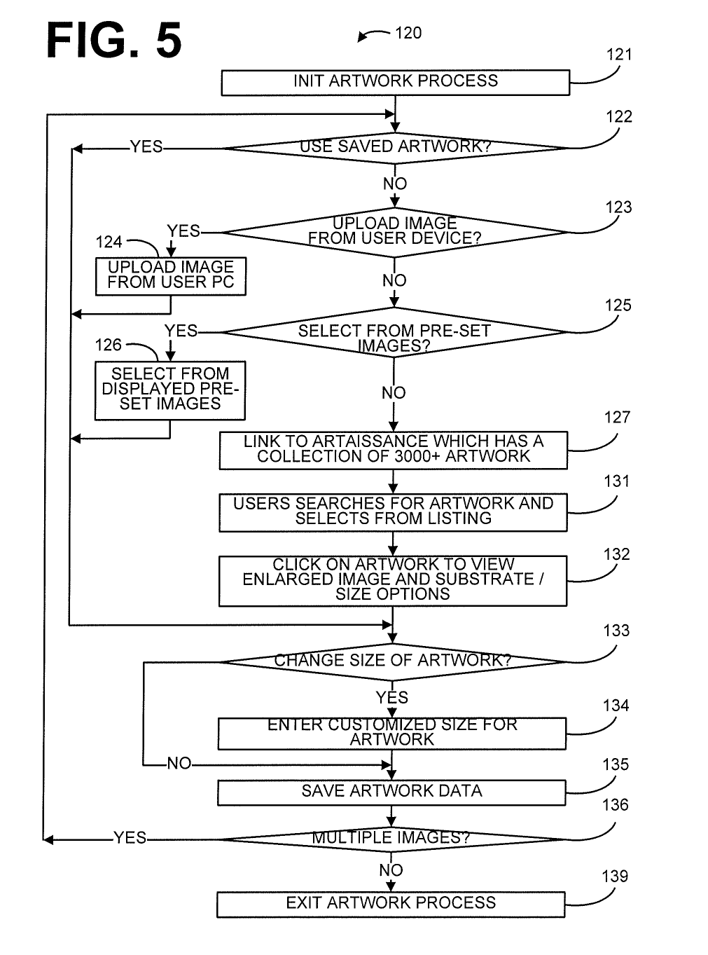

At step 106, the custom framing system 100 determines if the action received is a choose artwork request. If it is determined at step 106 that the action received is not a choose artwork request, then the custom framing system 100 skips to step 108. However, if is determined at step 106 that the action received is a choose artwork request, then the custom framing system 100 performs the artwork process at step 107. The artwork process is herein defined in further detail with regard to FIG. 5. After performing the artwork process, the custom framing system 100 skips to step 118.

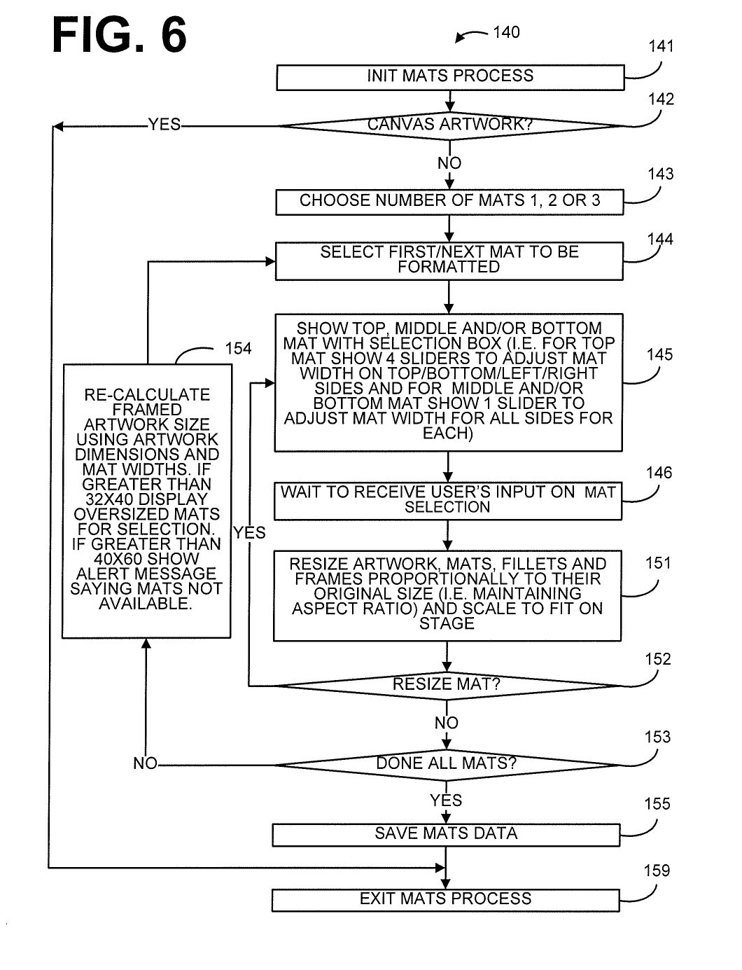

At step 108, the custom framing system 100 determines if the action received is a choose mats request. If it is determined at step 108 that the action received is not a choose mats request, then the custom framing system 100 skips to step 111. However, if is determined at step 108 that the action received is a choose mats request, then the custom framing system 100 performs the mats process at step 109. The mats process is herein defined in further detail with regard to FIG. 6. After performing the read process, the custom framing system 100 skips to step 118.

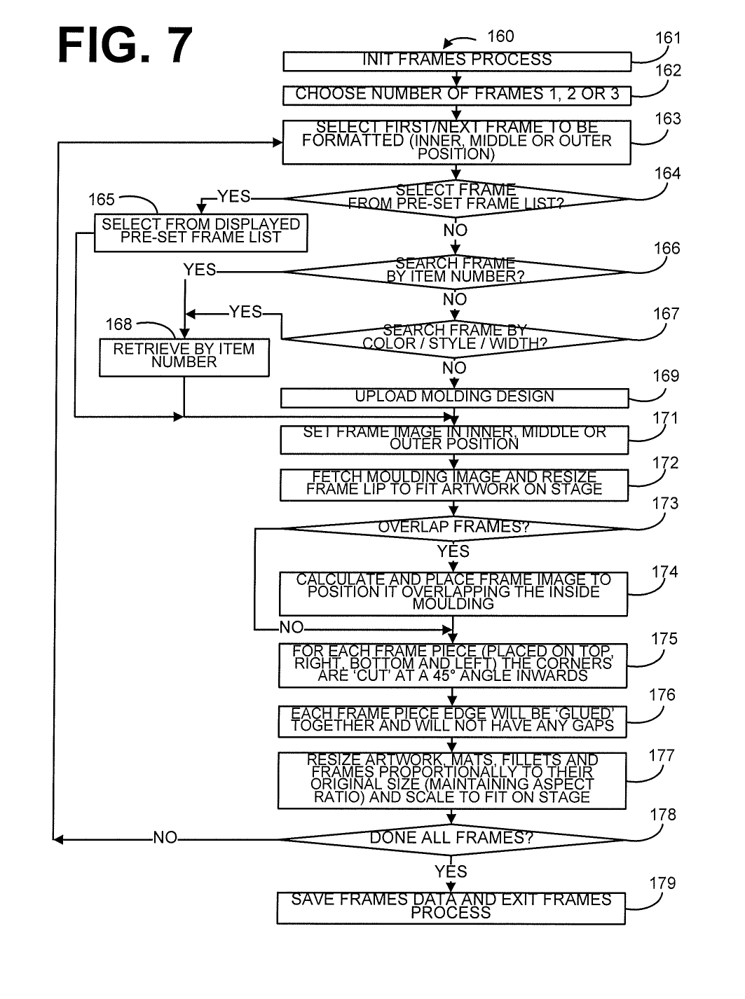

At step 111, the custom framing system 100 determines if the action received is a choose frames request. If it is determined at step 111 that the action received is not a choose frames is request, then the custom framing system 100 skips to step 113. However, if is determined at step 111 that the action received is a choose frames request, then the custom framing system 100 performs the frames process at step 112. The frames process is herein defined in further detail with regard to FIG. 7. After performing the frames process, the custom framing system 100 skips to step 118.

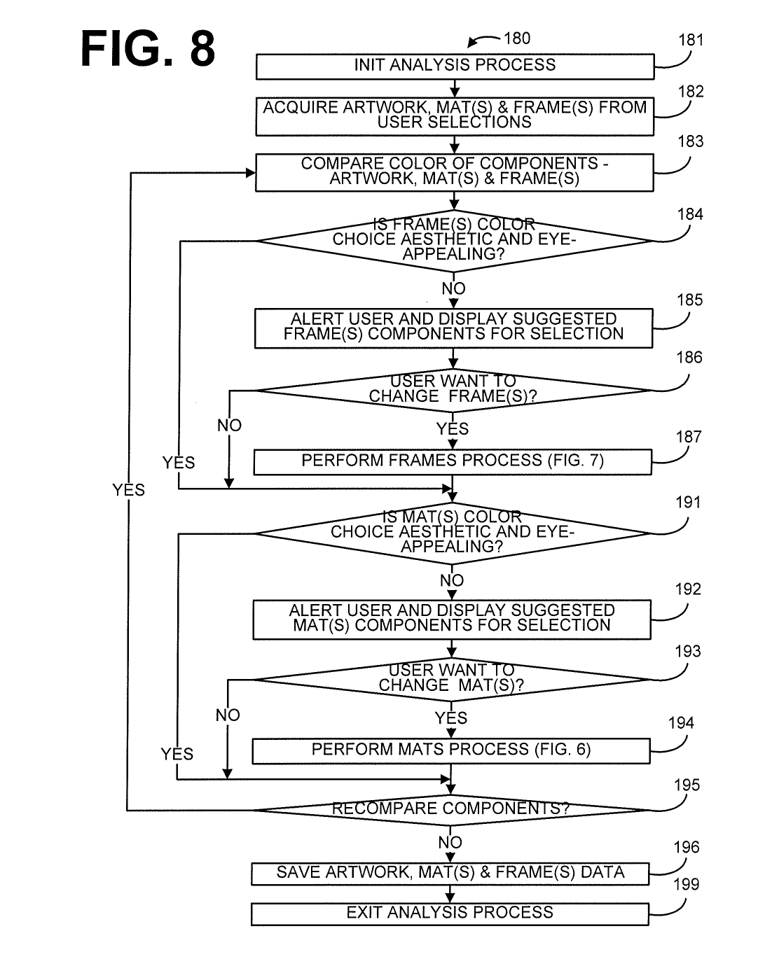

At step 113, the custom framing system 100 determines if the action received is an analyze combinations request. If it is determined at step 113 that the action received is not an analyze combinations request, then the custom framing system 100 skips to step 115. However, if is determined at step 113 that the action received is an analyze combinations request, then the custom framing system 100 performs the analysis process at step 114. The analyze process is herein defined in further detail with regard to FIG. 8. After performing the analyze process, the custom framing system 100 skips to step 118.

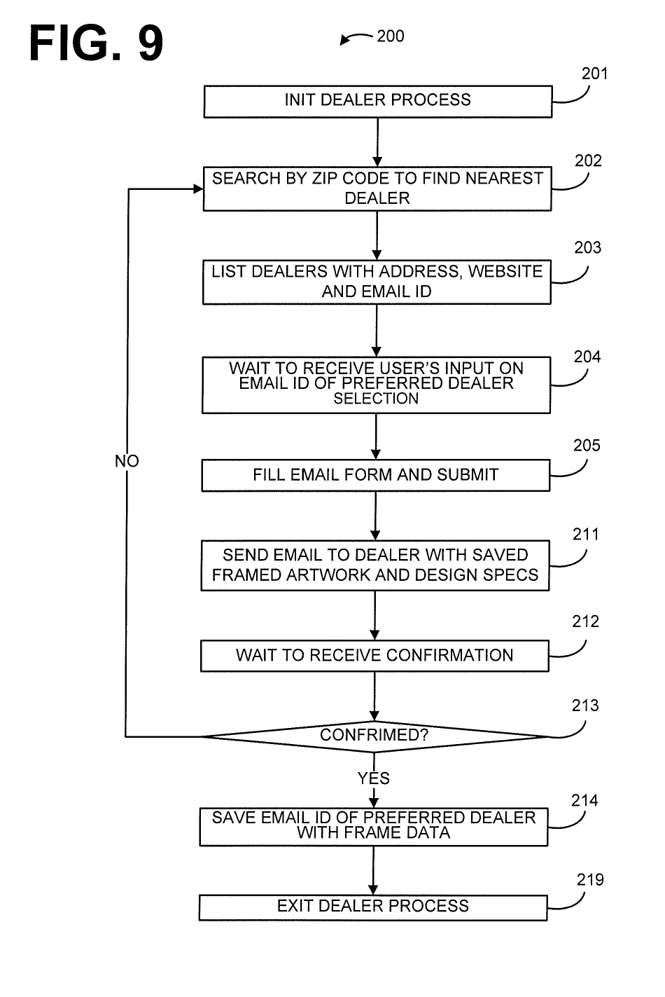

At step 115, the custom framing system 100 determines if the action received is a search for a dealer request. If it is determined at step 115 that the action received is not a search for a dealer request, then the custom framing system 100 skips to step 117. However, if is determined at step 115 that the action received is a search for a dealer request, then the custom framing system 100 performs the dealer process at step 116. The dealer process is herein defined in further detail with regard to FIG. 9. After performing the analyze process, the custom framing system 100 skips to step 118.

At step 117, it is assumed that the project is completed so the custom framing system 100 save the specifications for the project.

At step 118, the custom framing system 100 determines if there are more actions to be received for processing. If it is determined at step 118 that there are more actions to be processed, then the custom framing system 100 returns to repeat steps 102-118. However, if it is determined at step 118 that there are no more actions to be processed, then the custom framing system 100 exits at step 119.

FIG. 5 is a flow chart illustrating an example of the operation of the artwork process 120 on the server 11 that is utilized in the custom framing system 100 of the present invention, as shown in FIGS. 2 and 4. The artwork process 120 enables a customer to select the artwork to be matted and framed. The artwork may be obtained from a variety of different locations including, but not limited to, selected from a preset of images, uploaded from a user's PC, or acquired from a network. In one embodiment, the network is the World Wide Web, and the artwork is acquired from a website.

First at step 121, the artwork process 120 is initialized. This initialization includes a startup routines and processes embedded in the BIOS of the server 11. The initialization also includes the establishment of data values for particular data structures utilized in the server 11.

At step 122, it is determined if the artwork process 120 is to use artwork from a previously saved project. If it is determined at step 122 that the artwork process is to use artwork from a previously saved project, then the artwork process 120 skips to step 133. However, if it is determined at step 122 that artwork from a previously saved project is not to be utilized, then the artwork process 120 determines if the artwork process 120 is to upload an image from the user device, at step 123. If it is determined at step 123 that the artwork is not to be acquired from the user device, then the artwork process 120 skips to step 125. However, if it is determined at step 123 that the artwork is to be uploaded from the user's PC, then that artwork image is uploaded from the user PC at step 124. The artwork process 120 then skips to step 133.

At step 125, the artwork process 120 determines if the artwork image is to be selected from a preset of images. If it is determined at step 125 that the artwork image is not to be selected from a preset of artwork images, then the artwork process 120 skips to step 127. However, if it is determined at step 125 that the artwork image is to be selected from a preset of images, then the artwork process 120 enables the user to select the artwork image from a preset of images at step 126. These preset artwork images are general images provided by the custom framing system 100. The artwork process 120 then skips to step 133.

It is assumed that the artwork image is to be selected from a website on the World Wide Web if another option has not previously been selected. At step 127, the artwork process 120 provides at least one link to a collection of artwork images. At step 131, the artwork process 120 enables a user to search for artwork and select an artwork image from the listing. At step 132, the artwork process 120 enables the artwork image selected by the user at step 131 to be enlarged or substrate/size options to be selected. At step 133, the artwork process 120 determines if the user decided to change the size of the artwork. If it is determined at step 133 that the user did not change the size of the artwork, then the artwork process 120 skips to step 135. However, if it is determined at step 133 that the size of the artwork was changed, then the artwork process 120 in terms of custom size for that artwork step 134.

At step 135, the artwork process 120 saves the artwork data as an artwork project. At step 136, it is determined if multiple images are to be utilized in the current framing project. In one embodiment, the custom framing system of the present invention offers the ability to select multiple images to fit multiple mat openings in one frame configuration. For example, a need to visualize such a configuration could be family photographs of parents and their children all in one frame. The multiple mat openings include, but are not limited to, a variety of shapes besides the standard rectangle, circle, oval, hexagon, and the like. If it is determined that multiple images are to be utilized for the current framing project, then the artwork process 120 returns to repeat steps 122-136. However, if it is determined that multiple images are not to be used for the current framing project, then the artwork process 120 exits at step 139.

FIG. 6 is a flow chart illustrating an example of the operation of the mats process 140 on the server 11 that is utilized in the custom framing system 100 of the present invention, as shown in FIGS. 2 and 4. A mats process 140 enables a user to select one or more mats surrounding an artwork image. If a framing project includes multiple maps, the mats process 140 further enables a user to design the framing project with layer the mats and to determine the reveal of each mat when you have a multiple of mats in a layered configuration.

First at step 141, the mats process 140 is initialized. This initialization includes a startup routines and processes embedded in the BIOS of the server 11. The initialization also includes the establishment of data values for particular data structures utilized in the server 11.

At step 142, the mats process 140 determines if the artwork image is on canvas. If it is determined at step 142 that the artwork image is on canvas, then the mats process 140 skips to step 159. The reason for not allowing a mat on a canvas artwork, is in the picture framing industry, mats are generally not used on canvas artwork. Instead, liners are optionally used (a form of molding). However, if it is determined in step 142 that the artwork image is not on canvas, then the mats process 140 enables a user to choose the number of mats to be selected at step 143. Also at step 143, the mats process 140 retrieves any mats selected in a retrieved prior framing project.

At step 144, the mats process 140 enables the user to select the first or next mat to be formatted. In one embodiment, the custom framing system 100 of the present invention offers the ability to select multiple images to fit multiple mat openings in one frame configuration. For example, a need to visualize such a configuration could be family photographs of parents and their children all in one frame. The multiple mat openings include, but are not limited to, a variety of shapes besides the standard rectangle, circle, oval, hexagon, and the like.

At step 145, then that is process 140 shows the top, middle and/or bottom that with the selection box. The selection box will include four sliders to adjust the top mat width on the top, bottom, left and right sides. The selection box also includes one slider for middle and/or bottom that to adjust the mat width for all sides. This enables a user to custom fit an artwork image with mats when there are multiple maps to be included on the project. At step 146, the mats process 140 then waits to receive the user's input on the mat being formatted selection. At step 151, the mats process 140 enables the user to resize the artwork, mats, fillets and frames proportionally to their original size in order to maintain the aspect ratio and scaled to fit the artwork and mats on the screen.

At step 152, the mats process 140 determines if the mat currently being formatted is to be resized. If it is determined at step 152 that the mat currently being formatted is to be resized, then the mats process 140 returns to repeat steps 145-152. However, if it is determined at 152 that the current mat being formatted is not to be resized, then the mats process 140 determines at step 153 whether additional mats for the artwork project were to be formatted. If it is determined at step 153 that no additional mats are to be formatted, then the mats process 140 skips to step 155. However, if it is determined at step 153 that the mats of the artwork project are to be reformatted, then the mats process 140 then recalculate the framed artwork size using the artwork dimensions and mat width at step 154. This recalculation of the framed artwork size determines if the outside mat dimension is greater than a standard size mat, if yes only display the oversized mats. If the outside dimension is greater than the size of the oversized mat, then show a warning. After performing the recalculation of the framed artwork size, the mats process 140 returns to repeat steps 144-153.

At step 155, the mats process 140 saves all the formatted mats data for the artwork project, and then exits at step 159.

FIG. 7 is a flow chart illustrating an example of the operation of the frames process 160 utilized in the custom framing system 100 of the present invention, as shown in FIGS. 2 and 4. The frames process 160 enables a user to join the four sides of moldings together at the corners that show no gaps in the joins. A neat join at the corners is what one expects from a good custom framer, and this is what can be shown to the user. The frames process 160 also enables the user to determine amount of the frame that shows.

First at step 161, the frames process 160 is initialized. This initialization includes a startup routines and processes embedded in the BIOS of the server 11. The initialization also includes the establishment of data values for particular data structures utilized in the server 11.

At step 162, the frames process 160 receives the user's choice on the number of frames to be utilized in the current framing project. Also at step 162, the frames process 160 retrieves any frames selected in a retrieved prior framing project.

At step 163, the frames process 160 receives the user's choice on the first/next frame to be formatted (i.e. inner, middle or outer frame position). At step 164, it is determined if the frame to be formatted is to be selected from a preset frame list. If it is determined at step 164 that the frame to be formatted is not to be selected from a preset frame list, then the frames process 160 skips to step 166. However, if it is determined in step 164 that the frame to be formatted is to be selected from a preset frame list, then the frames process 160 displays a preset frame list and accepts the user's choice of frame from the list at step 165. After receiving the user's frame choice from the preset frame list, the frames process 160 then skips to step 171.

At step 166, it is determined if the frame to be formatted is to be selected by item number. If it is determined at step 166 that the frame to be formatted is to be selected by item number, then the frames process 160 skips to step 168. However, if it is determined in step 166 that the frame to be formatted is not to be selected by item number, then the frames process 160 determines if the frame to be formatted is to be search for by the desired frame type by color, style or width, at step 167. If it is determined at step 167 that the frame to be formatted is not to be selected by color, style or width, then the frames process 160 skips to step 169. However, if it is determined in step 166 that the frame to be formatted is to be selected by color, style or width, then the frames process 160 displays all the frames matching the color, style or width selected by the user along with each frames item number.

At step 168, the frames process 160 enables the user to select the desired frame by item number for all the displayed frames. After receiving the user's frame choice by item number, the frames process 160 then skips to step 171.

At step 167, the frames process 160 enables a user to search for the desired frame type by color, style or width. The frames process 160 also provides as an option, the ability to enable the user to upload a molding design. In addition, the frames process 160 also provides the user to the ability to define the type of finish or color, pattern or texture to be applied to the molding or frame. The frames process 160 thus offers customization with different finishes for moldings and add-on ornaments (i.e. Rosettes for the frame corners). This enables the user to visualize the result of selecting different finishes (gold, silver, metallic, etc.) for the moldings, and add-on ornaments (leaf, flower, etc.).

At step 171, the frames process 160 sets the frame image in the positions selected at step 163. At step 172, the molding image is acquired and the frame image is resized to fit the artwork previously selected.

At step 173, it is determined if there are overlapping frames. If it is decided at step 173 that there are not overlapping frames, then the frames process 160 skips to step 175. However, if it is determined at step 173 that there are to be overlapping frames, then the frames process 160 calculates the image and places the frame image to over the overlapping inside of the molding at step 174. Most frames are back-loaded, (i.e., glass, mats, art, etc. are dropped in from the backside of the frame), with a lip to hold it all in place. A float frame is used to frame a canvas. The cross-section of the moldings used is I′ shape with a base/lip that holds the canvas. It is front-loaded so the entire canvas shows.

At step 175, for each frame piece image (i.e. top, right, bottom and left) the corners are cut at a 45° angle inwards. At step 176, each frame piece edge will then be “glued” together so as not to show any gaps between the pieces. At step 177, the frames process 160 resizes the artwork, mats, plays and frames proportionally to their original size maintaining the aspect ratio and scale to fit

At step 178, it is determined if there are additional frames to be formatted. If it is determined in step 177 that there are more frames to be formatted, then the frames process 160 returns to repeat steps 163-178. However, if it is determined at step 178 that there are no more frames to be formatted, then the frames process 160 saves the current project frame data and exits at step 179.

FIG. 8 is a flow chart illustrating an example of the operation of the analysis process 180 utilized in the custom framing system 100 of the present invention, as shown in FIGS. 2 and 4. The analysis process 180 uses a set of design rules to avoid aesthetically bad choices of components. For example, a predominantly dark blue image will not be eye appealing with a blue mat and a black molding. Through analysis, the analysis process 180 will display components for selection considered appropriate by the industry design experts. An override feature will also be added for any user who wants to pass on the suggestions.

First at step 181, the analysis process 180 is initialized. This initialization includes a startup routines and processes embedded in the BIOS of the server 11. The initialization also includes the establishment of data values for particular data structures utilized in the server 11.

At step 182, the analysis process 180 acquires the artwork, mat(s) and frame(s) from the user's selections. At step 183, the analysis process 180 compares the color of the components in the framing project, where the components include the artwork, mat(s) and frame(s).

At step 184, it is determined if the frame color choice is aesthetic and eye pleasing. If it is determined at step 184 that the frame color choice is aesthetic and eye pleasing, then the analysis process 180 then skips to step 191. However, if it is determined at step 184 that the frame color is not aesthetic or eye pleasing, then the user is alerted and a display of suggested frame components is presented to the user at step 185. At step 186, the analysis process 180 determines if the user wants to change the frame components. If it is determined at step 186 that the user does not want the change frame components, then the analysis process 180 skips to step 191. However, if it is determined at step 186 that the user does want the change frame components, then the analysis process 180 performs the frame process at step 187. The frames process 160 was herein defined in further detail with regard to FIG. 7.

At step 191, it is determined if the mat color choice is aesthetic and eye pleasing. If it is determined at step 184 that the mat color choice is aesthetic and eye pleasing, then the analysis process 180 then skips to step 195. However, if it is determined at step 191 that the mat color is not aesthetic or eye pleasing, then the user is alerted and a display of suggested mat components is presented to the user at step 192. At step 193, the analysis process 180 determines if the user wants to change the mat components. If it is determined at step 193 that the user does not want the change mat components, then the analysis process 180 skips to step 195. However, if it is determined at step 193 that the user does want the change mat components, then the analysis process 180 performs the mat process at step 194. The mats process 140 was herein defined in further detail with regard to FIG. 6.

At step 195, it is determined if the user wants to read can pair or analyze the new components. It is determined at step 195 that the user does wish to re-compare the components, then the analysis process 180 returns to repeat steps 183-195. However, if it is determined in step 195 that the user does not wish to re-compare the components, then the analysis process 180 save the current artwork, mat(s) and frame(s) data in the current frames project at step 196. At step 199, the analysis process 180 then exits.

FIG. 9 is a flow chart illustrating an example of the operation of the dealer process 200 utilized in the custom framing system 100 of the present invention, as shown in FIGS. 2 and 4. A dealer process 200 enables the searching and selecting of a framing industry dealer to receive the configuration or the framing design specs along with the picture of the framing job.

First at step 201, the dealer process 200 is initialized. This initialization includes a startup routines and processes embedded in the BIOS of the server 11. The initialization also includes the establishment of data values for particular data structures utilized in the server 11.

At step 202, the dealer process 200 performs a search by a zip code input by the user a list of dealers with their addresses, website and e-mail ID are displayed at step two of three. At step 204, the dealer process 200 waits to receive the user's input on the e-mail ID of the preferred dealer. At step 205, after receiving the user input, the dealer process 200 fills-out the e-mail form for the user to submit. At step 211, the e-mail is sent to the selected dealer along with the saved artwork and frame design components. At step 212, the dealer process 200 waits to receive an e-mail confirmation that the selected dealer received the request.

At step 213, the dealer process 200 determines if the confirmation received from the selected dealer was positively confirmed. If it is determined at step 213 that the selected dealer did not positively confirm the receipt of the order, then the dealer process 200 returns to repeat steps 202-213. However, if it is determined at step 213 that the selected dealer did positively confirm the order was received, then the dealer process 200 save the e-mail ID of the preferred dealer with the frame data in the current framing project at step 214 and exits at step 219

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may in fact be executed substantially concurrently or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be emphasized that the above-described embodiments of the present invention, particularly any “preferred” embodiments, are merely possible examples of implementations set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for designing custom framework components for an image, comprising:
receiving the image to be framed;
determining if the image to be framed is to include a mat as one of the framework components;
determining if a molding is to be utilized as one of the framework components; and
resizing the framework components in proportion to the image to be framed.

2. The method of claim 1, wherein the mat includes a plurality of mats.

3. The method of claim 2, wherein the plurality of mats are different colors.

4. The method of claim 2, wherein the plurality of mats are different widths.

5. The method of claim 1, wherein the molding includes a plurality of moldings.

6. The method of claim 5, wherein the plurality of moldings are stacked.

7. The method of claim 1, further comprising:
displaying the image with the framework components framing the image, wherein the corners of the moldings appear as mitered joints.

8. A computer program product for designing custom framework components for an image, the computer program product comprising:
a tangible storage medium readable by a computer system and storing instructions for execution by the computer system for performing a method comprising:
receiving the image to be framed;
determining if the image to be framed is to include a mat as one of the framework components;
determining if a molding is to be utilized as one of the framework components; and
resizing the framework components in proportion to the image to be framed.

9. The computer program product of claim 8, wherein the mat includes a plurality of mats.

10. The computer program product of claim 8, wherein the plurality of mats are different colors.

11. The computer program product of claim 8, wherein the plurality of mats are different widths.

12. The computer program product of claim 8, wherein the molding includes a plurality of moldings.

13. The computer program product of claim 12, wherein the plurality of moldings may be stacked.

14. The computer program product of claim 12, further comprising:
displaying the image with the framework components framing the image, wherein the corners of the moldings appear as mitered joints.

15. A system for designing custom framework components for an image, comprising:
an image module that receives the image to be framed;
a mat module that determines if the image to be framed is to include a mat as one of the framework components;
a molding module that determines if a molding is to be utilized as one of the framework components; and
a resizing module that resizes the framework components in proportion to the image to be framed.

16. The system of claim 15, wherein the mat includes a plurality of mats.

17. The system of claim 16, wherein the plurality of mats are different colors.

18. The system of claim 16, wherein the plurality of mats are different widths.

19. The system of claim 15, wherein the molding includes a plurality of moldings.

20. The system of claim 19, wherein the plurality of moldings may be stacked.

21. The system of claim 15, further comprising:
a display module that displays the image with the framework components framing the image, wherein the corners of the moldings appear as mitered joints.
